(19) United States
(12) Patent Application Publication
(10) Pub. No.: US 2012/0026996 A1
(43) Pub. Date: Feb. 2, 2012

(54) COMMUNICATIONS DEVICE FOR PERFORMING WIRELESS COMMUNICATIONS, WIRELESS COMMUNICATIONS SYSTEM, WIRELESS COMMUNICATIONS METHOD, AND STORAGE MEDIUM

(75) Inventor: Satoru Yamaguchi, Nagoya-shi (JP)

(73) Assignee: BUFFALO INC., Nagoya-shi (JP)

(21) Appl. No.: 13/189,574

(22) Filed: Jul. 25, 2011

(30) Foreign Application Priority Data
Jul. 30, 2010 (JP) 2010-171810

(51) Int. Cl. H04W 88/02; H04W 88/08

(52) U.S. Cl. 370/338

(57) ABSTRACT

A communications device for performing wireless communications includes: a data receiving section for receiving data by wireless communications; a data transmitting section for transmitting data by wireless communications; a mode switching section for switching an operation mode of the communications device between a first mode in which power is supplied to the data transmitting section, and a second mode in which power consumption in at least the data transmitting section is minimized over that in the first mode; and a determination section for determining whether the data receiving section has received designated data. The mode switching section switches the operation mode of the communications device from the second mode to the first mode if, in a state in which the communications device is in the second mode, the determination section has determined that the data receiving section has received the designated data.

### CROSS REFERENCE TO RELATED APPLICATION

The disclosure of Japanese Patent Application No. 2010-171810, filed on Jul. 30, 2010, is incorporated herein by reference.

### BACKGROUND OF THE INVENTION

1. Field of the Invention

The present invention relates to communications devices for performing wireless communications.

2. Description of the Background Art

Wireless communications systems whereby wireless communications among a plurality of communications devices are carried out are known. In such wireless communications systems, as disclosed in, for example, Japanese Laid-Open Patent Publication No. 2005-109850, access points and terminal devices that are non-access-point stations are used as the communications devices, to perform wireless communications between the access points and the terminal devices. In such wireless communications systems, the communications devices in some instances are configured with a mode for minimizing power consumption (power-saving mode).

However, communications devices configured with a power-saving mode risk being inadequately convenient. For example, a user using a terminal device to attempt to carry out wireless communications with an access point configured with a power-saving mode must directly operate the access point to carry out releasing of the power-saving mode and associated operations, which has been likely to increase the burden on the user.

### SUMMARY OF THE INVENTION

An object of the present invention, brought about taking the above-described factors into consideration, is to make available technology enabling usability of communications devices configured with a power-saving mode to be improved.

The present invention is made to solve at least a portion of the problems described above. A first aspect of the present invention is directed to a communications device for performing wireless communications, and the communications device includes: a data receiving section for receiving data by wireless communications; a data transmitting section for transmitting data by wireless communications; a mode switching section for switching an operation mode of the communications device between a first mode in which power is supplied to the data transmitting section, and a second mode in which power consumption in at least the data transmitting section is minimized over that in the first mode; and a determination section for determining whether the data receiving section has received designated data. In the communications device, the mode switching section switches the operation mode of the communications device from the second mode to the first mode if, in a state in which the communications device is in the second mode, the determination section has determined that the data receiving section has received the designated data.

Further, the communications device preferably includes, as the data receiving section, a first data receiving unit that operates in the first mode and does not operate in the second mode, and a second data receiving unit that consumes less power than the first data receiving unit and operates in the second mode. The determination section preferably determines whether the second data receiving unit has received the designated data. The mode switching section preferably switches the operation mode of the communications device from the second mode to the first mode if, in a state in which the communications device is in the second mode, the determination section has determined that the second data receiving unit has received the designated data.

Further, the communications device is preferably a relay device that relays communications data between a wireless communications terminal and another communications device. Preferably, the data receiving section receives communications data from the wireless communications terminal and said other communications device by wireless communications, and the data transmitting section transmits communications data to the wireless communications terminal and said other communications device by wireless communications.

Further, it is preferable that the communications device further includes an identification data memory section storing identification data for identifying the communications device, and the designated data includes identification data matching the identification data stored in the identification data memory section.

Further, it is preferable that the communications device further includes an authentication data memory section storing authentication data, and the designated data includes authentication data that is deemed legitimate by being compared with the authentication data stored in the authentication data memory section.

Further, it is preferable that the mode switching section does not carry out switching of the communications device operation mode if, in a state in which the communications device is in the second mode, the determination section determines that the data receiving section has not received the designated data.

Further, it is preferable that the data receiving section receives encrypted data, the communications device further includes a decryption section for transforming, by a decryption process, the encrypted data into the original data that the data was prior to being encrypted, and the determination section determines that the data receiving section has received the designated data if the original data is the designated data.

Further, the designated data is preferably contained in a probe request.

A second aspect of the present invention is directed to a wireless communications system, and the wireless communications system includes: a first communications device; and a second communications device for performing wireless communications with the first communications device. In the wireless communications system, the first communications device includes a designated data transmitting section for transmitting designated data to the second communications device by wireless communications, and the second communications device includes: a data receiving section for receiving data from the first communications device by wireless communications; a data transmitting section for transmitting data to the first communications device by wireless communications; a mode switching section for switching an operation mode of the second communications device between a first mode in which power is supplied to the data transmitting section, and a second mode in which power consumption in at least the data transmitting section is minimized over that in the first mode, and a determination section for determining whether the data receiving section has received the designated data. In the wireless communications system, the mode switching section of the second communications device switches the operation mode of the second communications device from the second mode to the first mode if, in a state in which the second communications device is in the second mode, the determination section has determined that the data receiving section has received the designated data.

A third aspect of the present invention is directed to a communications device for performing wireless communications, and the communications device includes a designated data transmitting section for transmitting designated data for switching, in respect of another communications device having, as operation modes, a first mode in which power is supplied to its data transmitting section for transmitting data by wireless communications and a second mode in which power consumption in at least the data transmitting section is minimized over that in the first mode, the operation mode of the other communications device from the second mode to the first mode.

The present invention is also directed to a storage medium having stored therein a method and a program executed by the communications device and system described above.

According to the present invention, it is possible to improve usability of a communications device which can be put in power-saving mode.

The present invention is applicable to, for example, wireless communications devices, in particular, wireless communications devices which can be put in power-saving mode. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a network system according to embodiments of the present invention;

FIG. 2 is a block diagram illustrating a configuration of a relay device according to a first embodiment of the present invention;

FIG. 3 is a diagram illustrating a MAC frame;

FIG. 4 is a flow chart showing wake-up process performed by the relay devices according to the first embodiment and a third embodiment of the present invention;

FIG. 5 is a block diagram illustrating a configuration of a relay device in a network system according to a second embodiment of the present invention;

FIG. 6 is a flow chart showing wake-up process performed by the relay device according to the second embodiment of the present invention; and

FIG. 7 is a block diagram illustrating a configuration of a relay device 100B in a network system according to the third embodiment of the present invention.

### DESCRIPTION OF THE PREFERRED EMBODIMENTS

Hereinafter, embodiments and modifications of the present invention will be described.

### First Embodiment

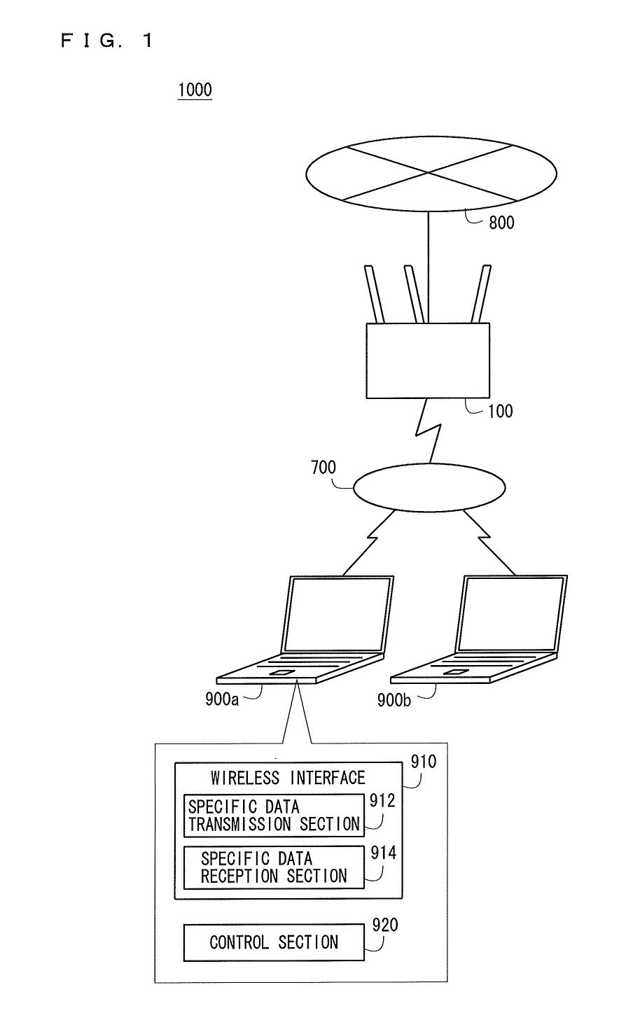

A configuration of a first embodiment will be described. FIG. 1 is a diagram illustrating a network system 1000 according to the present embodiment. The network system 1000 includes: a relay device 100, which is a first communications device; a network 800, which is wire-connected to the relay device 100; and wireless communications terminals 900a and 900b, which are second communications devices connecting to the relay device 100 by wireless communications. The network 800 is a so-called LAN (local area network), and is connected to the Internet via a not-illustrated router. The relay device 100, and the wireless communications terminals 900a and 900b are each a wireless LAN communications device compliant with, for example, the Institute of Electrical and Electronics Engineers (IEEE) 802.11n standard. The relay device 100 and the wireless communications terminals 900a and 900b may be compliant with any of the IEEE 802.11a, b, and g standards. Further, the relay device 100 and the wireless communications terminals 900a and 900b may be compliant with a standard other than the IEEE 802.11 standard.

The wireless communications terminals 900a and 900b of the present embodiment are non-access-point stations, and are personal computers having similar configurations. It is to be noted that not only personal computers but also any communications devices capable of wireless communications can be used as the wireless communications terminals 900a and 900b. For example, household electric appliances (for example, televisions, video cameras, and video recorders) having a wireless communications function, mobile telephones, and PDAs can be used as the wireless communications terminals 900a and 900b.

The wireless communications terminal 900a includes a wireless interface 910 and a control section 920. The control section 920 is a computer including a CPU (illustration omitted) and a memory (illustration omitted), and can realize various functions by executing programs stored in a memory. For example, the control section 920 controls the wireless interface 910. The wireless communications terminal 900b also has the same configuration as the wireless communications terminal 900a.

The wireless interface 910 performs communications via three antennas (illustration omitted) by using a wireless network 700. The wireless communications in compliance with, for example, the IEEE 802.11n standard are performed as described above. The wireless communications in compliance with any of the IEEE 802.11a, b, and g standards, or a standard other than the IEEE 802.11 standard, may be performed.

The wireless interface 910 includes a designated data transmitting section 912 and a designated data receiving section 914. The wireless interface 910 (including the designated data transmitting section 912 and the designated data receiving section 914) is implemented by a dedicated hardware circuit. The designated data transmitting section 912 transmits various data such as a probe request described below via the wireless network 700. The designated data receiving section 914 receives various data such as a probe response described below via the wireless network 700.

The relay device 100 is an access point which performs wireless communications with the wireless communications terminals 900a and 900b by using the wireless network 700, and is compliant with the same wireless communications standard as the wireless communications terminals 900a and 900b. Specifically, for example, the relay device 100 is compliant with the IEEE 802.11n standard. The relay device 100 may be compliant with any of the IEEE 802.11a, b, and g standards, or a standard other than the IEEE 802.11 standard.

Further, the relay device 100 relays communications between various communications devices (for example, Web servers, mail servers, or other personal computers which are not illustrated) connected thereto via the network 800, and the wireless communications terminals 900a and 900b.

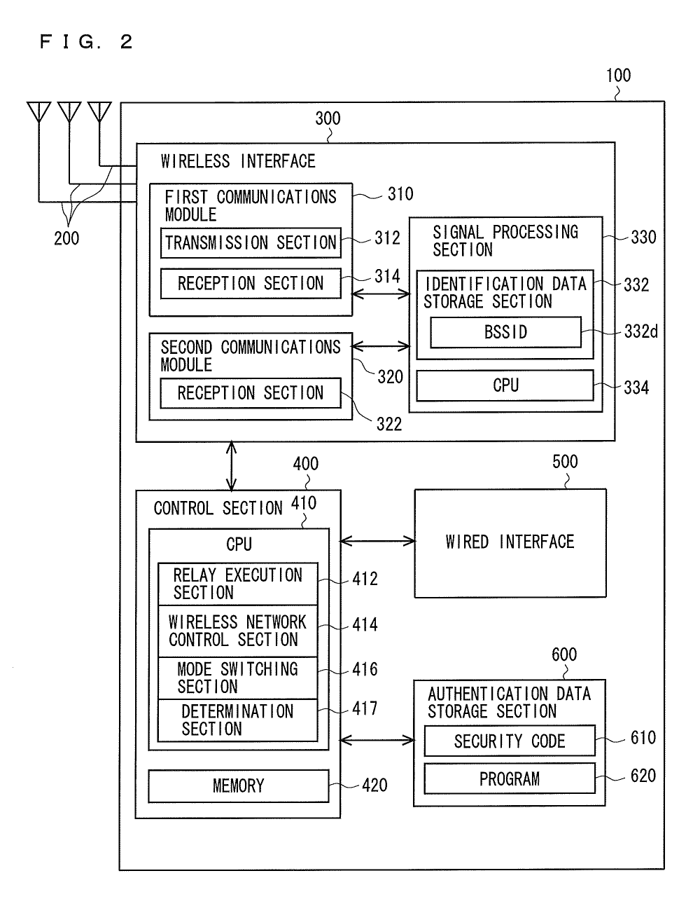

FIG. 2 is a block diagram illustrating a configuration of the relay device 100. The relay device 100 includes: antennas 200; a wireless interface 300 for performing wireless communications; a control section 400 for controlling the relay device 100; a wired interface 500 for performing wired communications; and an authentication data storage section 600 for storing various data. The relay device 100 is connected to a designated power supply (illustration omitted). Namely, the processing sections of the relay device 100 receive power supply from the designated power supply to operate.

The authentication data storage section 600 is a memory such as a writable non-volatile memory, and stores, for example, a security code 610 and programs 620. The security code 610 is used for performing authentication of the wireless communications terminals 900a and 900b in wake-up process described below. The programs 620 are programs having written therein a control method for controlling the relay device 100, and are executed by the control section 400. A hard disk, a flash memory, or the like can be used as the authentication data storage section 600.

The wireless interface 300 is an interface for wireless communications with the wireless communications terminals 900a and 900b described above. The wireless interface 300 performs communications via the antennas 200 by using the wireless network 700. In the present embodiment, the number of the antennas 200 is three (however, the number of the antennas may be one, two, four, or greater than four).

The wireless interface 300 includes a first communications module 310, a second communications module 320, and a signal processing section 330.

The first communications module 310 includes a data transmitting section 312 and a data receiving section 314 which are each configured as hardware including a high frequency amplifier circuit. The second communications module 320 includes a data receiving section 322 configured as hardware including a high frequency amplifier circuit. The data receiving sections 314 and 322 are referred to as a first data receiving section 314 and a second data receiving section 322, so as to be distinguished from each other. On the other hand, unlike the first communications module 310, the second communications module 320 has no transmitting section.

The data transmitting section 312 receives digital data from the signal processing section 330, and generates an electric signal of a specific frequency which is obtained by modulation according to the received digital data. The data transmitting section 312 emits the generated electric signal, as radio wave of the specific frequency, via the antennas 200. The data receiving sections 314 and 322 receive, as an electric signal, radio wave received by the antennas 200, and amplifies a specific frequency component contained in the received electric signal. Further, the data receiving sections 314 and 322 demodulate an electric signal of the amplified specific frequency component, to extract digital data, and transmit the extracted digital data to the signal processing section 330.

The data receiving section 322 of the second communications module 320 is configured so as to consume less power than the data receiving section 314 of the first communications module 310. Specifically, the data receiving section 322 of the second communications module 320 is configured so as to have an electric signal amplifying capability that is lower than the electric signal receiving capability of the data receiving section 314 of the first communications module 310. As a result, the communications speed that the data receiving section 322 of the second communications module 320 can handle is lower than the communications speed that the data receiving section 314 of the first communications module 310 can handle. The probe request described below is transmitted at the communications speed that the data receiving section 322 of the second communications module 320 can handle.

The signal processing section 330 is a computer which includes a CPU 334 and an identification data storage section 332. The identification data storage section 332 is, for example, a memory such as an EEPROM (electrically erasable programmable read-only memory). The signal processing section 330 performs a so-called layer 2 process (for example, addition of a MAC header), and a portion of layer 1 process (for example, addition of a physical header) for digital data. The layer 2 corresponds to the second layer (data link layer) of a so-called OSI (open systems interconnection) reference model, whereas the layer 1 corresponds to the physical layer of the OSI reference model. Specifically, when the signal processing section 330 receives digital data from one of the data receiving section 314 or the data receiving section 322, the signal processing section 330 transmits, to the control section 400, data of a frame body in the MAC frame represented by the digital data. Further, when the signal processing section 330 receives, from the control section 400, digital data to be transmitted, the signal processing section 330 adds a MAC header, a physical header, and the like to the received digital data, to generate digital data according to a frame format compliant with the IEEE 802.11 standard, and transmits the digital data to the data transmitting section 312. It is to be noted that the signal processing section 330 may transmit, to the control section 400, data of the MAC header in the MAC frame represented by the digital data which is received from one of the data receiving section 314 or the data receiving section 322.

The identification data storage section 332 stores a BSSID (basic service set identifier) 332d. The BSSID 332d is identification data for identifying the wireless interface 300 of the relay device 100. In the present embodiment, the BSSID 332d matches the MAC (media access control) address of the wireless interface 300.

As the operation modes of the relay device 100, a first mode and a second mode are executed. These operation modes will be described below.

When the operation mode of the relay device 100 is the first mode, the first communications module 310 (the data transmitting section 312 and the data receiving section 314) operates by power being supplied. When the operation mode of the relay device 100 is the second mode, the first communications module 310 (the data transmitting section 312 and the data receiving section 314) does not operate due to no power being supplied. Further, when the operation mode of the relay device 100 is the first mode, the second communications module 320 (the data receiving section 322) does not operate due to no power being supplied. When the operation mode of the relay device 100 is the second mode, the second communications module 320 (the data receiving section 322) operates by power being supplied.

Therefore, in the second mode, the first communications module 310 does not operate, and the second communications module 320 which consumes less power than the first communications module 310 operates, in the wireless interface 300. Therefore, it can be said that the second mode is a power-saving mode in which power consumption is minimized over the power consumption in the first mode. On the other hand, in the first mode, the first communications module 310 including the data transmitting section 312 operates in the wireless interface 300, and it can be said that the first mode is a normal operation mode in which data transmission and data reception are frequently performed.

The wired interface 500 is an interface for connection with a communications line compliant with the IEEE 802.3 standard. In the present embodiment, the wired interface 500 is used for connecting between the relay device 100 and the network 800. Further, the wired interface 500 may be compliant with any standard other than the IEEE 802.3 standard. For example, power line communication (PLC) may be used. Moreover, an interface for wireless communications may be used instead of the wired interface 500 used for wired communications.

The control section 400 is a computer including a CPU 410 and a memory 420 (for example, a DRAM: dynamic random access memory), and controls components of the relay device 100. The CPU 410 functions as various processing sections including: a relay execution section 412; a wireless network control section 414; a mode switching section 416; and a determination section 417 by executing the programs 620 stored in the authentication data storage section 600.

The wireless network control section 414, by controlling the wireless interface 300, sets up the wireless-communications-exploiting wireless network 700. For example, the wireless network control section 414 performs communications with a communications device configured with the same extended service set identifier (ESSID) setting.

The relay execution section 412 functions as a so-called repeater (hub) which relays communications among communications devices (for example, the wireless communications terminals 900a and 900b, and not-illustrated other communications devices) connected to the interfaces (the wireless interface 300 and the wired interface 500) for communications.

The determination section 417 determines whether the data receiving section 322 of the second communications module 320 receives designated data in the wake-up process described below. The designated data will be described below in detail.

The mode switching section 416 sets the operation mode of the relay device 100 into one of the first mode (normal operation mode) or the second mode (power-saving mode). Specifically, when the mode switching section 416 sets the operation mode of the relay device 100 into the first mode, the mode switching section 416 supplies power to the first communications module 310 from the designated power supply as described above, to operate the data transmitting section 312 and the data receiving section 314. Further, the mode switching section 416 supplies no power to the second communications module 320, and does not operate the data receiving section 322.

On the other hand, when the mode switching section 416 sets the operation mode of the relay device 100 into the second mode, the mode switching section 416 supplies power to the second communications module 320, to operate the data receiving section 322. Further, the mode switching section 416 supplies no power to the first communications module 310, and does not operate the data transmitting section 312 and the data receiving section 314.

In the present embodiment, the mode switching section 416 switches the operation mode between the first mode and the second mode in certain cases. For example, in a case where a first switching date and time determined by a user in advance has arrived, the mode switching section 416 switches the operation mode from the first mode to the second mode. On the other hand, in a case where a second switching date and time determined by a user in advance has arrived, the mode switching section 416 switches the operation mode from the second mode to the first mode.

The first switching date and time and the second switching date and time are determined as follows. For example, the relay device 100 may be made to receive the settings for the first switching date and time and the second switching date and time from the wireless communications terminal 900a or 900b connected to the relay device 100. In this case, a user can configure the relay device 100 with the first and second switching-date/time settings by operating the wireless communications terminal 900a or 900b. Further, the relay device 100 may be configured with the first and second switching-date/time settings from a user interface (illustration omitted) included in the relay device 100. In this case, a user can configure the relay device 100 with the first and second switching-date/time settings by directly operating the relay device 100. The first switching date and time may be set with the time at which a user ends use of the wireless communications terminal 900a or 900b as the criterion. The second switching date and time may be set with the time at which a user starts use of the wireless communications terminal 900a or 900b as the criterion.

Further, when the mode switching section 416 switches the operation mode between the first mode and the second mode, the operation mode may be switched according to, for example, a predetermined schedule. In this case, the mode switching section 416 receives an instruction from a user via the wireless communications terminal 900a or 900b, or via the user interface of the relay device 100, and may determine the schedule according to the received instruction. The schedule may have any form such as a form including a day of the week, a time, a date, and the like.

Further, the mode switching section 416 switches the operation mode from the second mode to the first mode in the wake-up process described below when the determination section 417 determines that the designated data is received, in addition to the operation mode being switched when an explicit instruction for setting is received from a user.

Next, the probe request will be described. When the operation mode is the second mode (power-saving mode), the first communications module 310 does not operate, so that the relay device 100 cannot perform two-way communications with the wireless communications terminals 900a and 900b. Therefore, a mechanism for enabling the operation mode of the relay device 100 to be switched by using a probe request used at the start of wireless communications is utilized for the relay device 100 and the wireless communications terminals 900a and 900b of the present embodiment. The probe request is defined as, for example, a kind of a management frame which is one type of the MAC frame in the IEEE 802.11 standard. The probe request is a management frame which is used by a communications device (in the present embodiment, the wireless communications terminals 900a and 900b) which is a non-access point station that is to perform wireless communications, when the communications device inquires whether an access point (in the present embodiment, the relay device 100) exists as a communications partner.

In the present embodiment, when the wireless communications terminal 900a or 900b starts wireless communications with the relay device 100, the designated data transmitting section 912 of the wireless communications terminal 900a or 900b transmits a probe request 10 to the relay device 100 as defined in, for example, the IEEE 802.11 standard. An exemplary case where wireless communications are performed between the wireless communications terminal 900a and the relay device 100 will be described below.

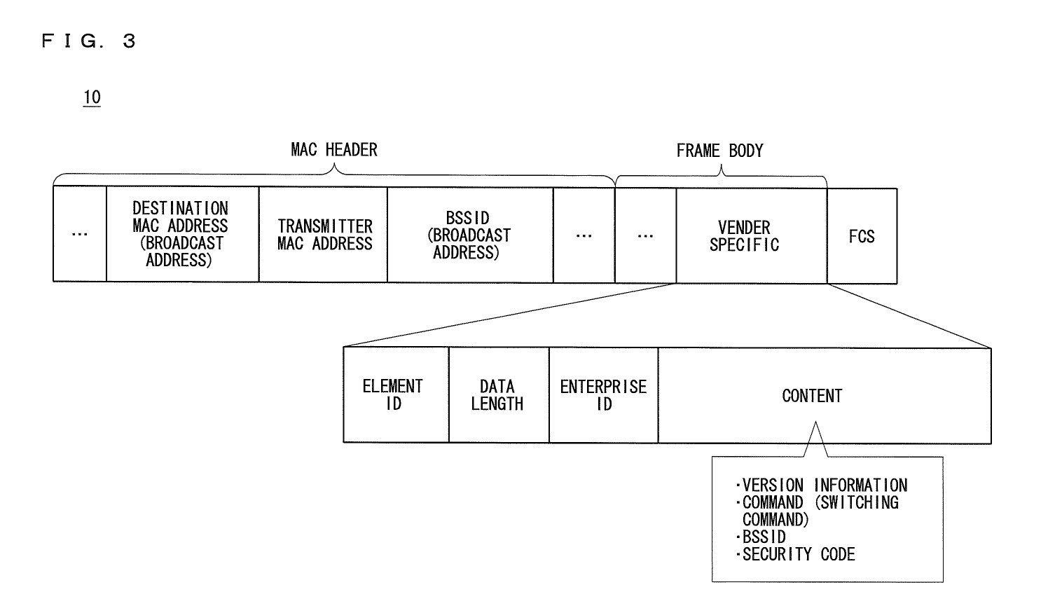

Firstly, a structure of the probe request 10 used in the present embodiment will be described. FIG. 3 is a diagram illustrating a structure of the probe request 10 used in the present embodiment. The probe request 10 is formed of a plurality of fields having stored therein a MAC header, a frame body, and an FCS (frame check sequence) which is error correction information, respectively.

In the management frame, the MAC header is formed of a plurality of fields which include fields having stored therein a destination MAC address, a transmitter MAC address, and a BSSID, respectively, as shown in FIG. 3. In the probe request 10, a broadcast address (specifically, a broadcast MAC address (FF:FF:FF:FF:FF:FF)) is contained in each of the fields having the destination MAC address and the BSSID stored therein. The MAC header further includes a frame control field, a sequence control field, and the like. The detailed description thereof is not given.

The frame body of the probe request 10 is formed of a plurality of fields (for example, a field in which an ESSID is written) having stored therein information compliant with, for example, the IEEE 802.11 standard. The detailed description of these fields is not given. A vendor specific field having stored therein contents uniquely defined by a vendor is located, as one of the plurality of fields, at the end of the frame body of the probe request 10. The vendor specific field is formed of fields having stored therein an element ID, a data length, an enterprise ID, and contents, respectively, as shown in FIG. 3. The element ID is an ID representing a type of data which is written in the subsequent fields. The element ID of the vendor specific field is represented by a hexadecimal number as “DD”. The data length is a value representing a data length from a portion immediately following the filed in which the data length is written, to the end of the vendor specific field. The enterprise ID is an identifier for identifying a vendor.

The probe request 10 of the present embodiment contains the data representing the following five kinds of information, as the contents of the vendor specific field.

(1) version information.
(2) switching command representing an instruction for switching from the second mode to the first mode.
(3) an actual data length representing the length of data which is contained as the contents.
(4) the BSSID for identifying the relay device 100.
(5) the security code for authentication by the relay device 100.

The designated data transmitting section 912 determines the BSSID and the security code according to an instruction from a user. The designated data transmitting section 912 transmits the probe request 10 which contains the data (1) to (5) described above, according to an instruction from the user.

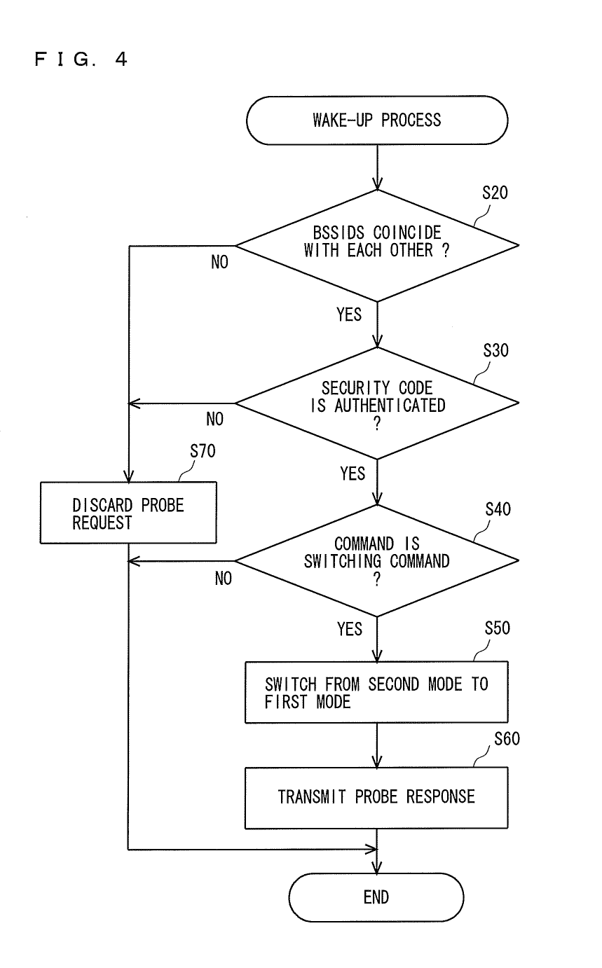

Next, the wake-up process performed by the relay device 100 will be described. FIG. 4 is a flow chart showing the wake-up process performed by the relay device 100. The wake-up process is executed by the relay device 100 when, for example, the data receiving section 322 of the second communications module 320 of the relay device 100 receives a probe request in a state where the operation mode of the relay device 100 is the second mode.

When the wake-up process is started, the determination section 417 of the relay device 100 reads the BSSID 332d from the identification data storage section 332 of the signal processing section 330. The determination section 417 determines whether the read BSSID 332d matches the BSSID contained in the contents of the vendor specific field in the probe request (Step S20).

When the determination section 417 determines that the read BSSID 332d matches the BSSID contained in the contents of the vendor specific field in the probe request (Step S20:YES), the determination section 417 performs authentication of the security code contained in the probe request (Step S30). Specifically, the determination section 417 reads the security code 610 from the authentication data storage section 600. The determination section 417 compares the read security code 610 with the security code contained in the contents of the vendor specific field in the probe request, to perform authentication of the security code contained in the probe request (Step S30). For example, when the security code 610 read from the authentication data storage section 600 is completely identical to the security code contained in the probe request, the determination section 417 authenticates the security code contained in the probe request. On the other hand, when the security code 610 read from the authentication data storage section 600 is not completely identical to the security code contained in the probe request, the determination section 417 does not authenticate the security code contained in the probe request.

When the determination section 417 authenticates the security code contained in the probe request (Step S30:YES), the determination section 417 determines that the probe request received by the data receiving section 322 is a probe request from an authenticated wireless communications terminal. The determination section 417 determines whether a command contained in the contents of the vendor specific field in the probe request is the switching command (Step S40).

When the determination section 417 determines that the command contained in the contents of the vendor specific field in the probe request is the switching command (Step S40:YES), the mode switching section 416 switches the operation mode of the relay device 100 from the second mode to the first mode (Step S50).

The wireless network control section 414 transmits a probe response from the data transmitting section 312 as a response to the probe request (Step S60). Thereafter, the relay device 100 ends the wake-up process. When the relay device 100 receives the authenticated probe request 10 as described with reference to FIG. 3, the process is advanced up to Step S60 in the wake-up process, and the operation mode of the relay device 100 is switched from the second mode to the first mode, and the probe response is transmitted from the relay device 100. Thereafter, a predetermined communications procedure such as authentication process compliant with the IEEE 802.11 standard is performed between the relay device 100 and the wireless communications terminal 900a, thereby realizing wireless communications between the relay device 100 and the wireless communications terminal 900a.

On the other hand, when the determination section 417 determines that the read BSSID 332d does not match the BSSID contained in the contents of the vendor specific field in the probe request (Step S20:NO), the probe request is discarded (Step S70). Further, also when the determination section 417 determines that the probe request does not contain a BSSID, the probe request is similarly discarded. The relay device 100 ends the wake-up process after the probe request is discarded.

Further, when the determination section 417 does not authenticate, in Step S30, the security code contained in the probe request (Step S30:NO), the probe request is discarded (Step S70). Further, also when the determination section 417 determines that the probe request does not contain a security code, the probe request is similarly discarded. The relay device 100 ends the wake-up process after the probe request is discarded.

When the determination section 417 determines, in Step S40, that the command contained in the contents of the vendor specific field in the probe request is a command other than the switching command, or when the probe request contains no command (Step S40:NO), the wake-up process is ended. When the probe request contains a command other than the switching command, the relay device 100 thereafter performs specific process based on the command.

In the network system 1000 described above, when the relay device 100 in the second mode receives the probe request, the relay device 100 executes the wake-up process (FIG. 4). When the received probe request is the authenticated probe request 10 including the designated data as shown in FIG. 3, the operation mode is switched from the second mode in which the first communications module 310 does not operate, to the first mode in which the first communications module 310 operates. Therefore, also when the relay device 100 is in the second mode, the wireless communications with the relay device 100 can be performed, for example, without requiring a user to directly operate the relay device 100. As a result, it is possible to improve usability of the relay device 100 which can be put in the second mode in which power consumption is minimized. For example, the relay device 100 may be located in a place (for example, a high place such as a ceiling) which makes direct operation thereof difficult, in some cases. In this case, if a user is required to directly operate the relay device 100 in order to switch the operation mode of the relay device 100 from the second mode to the first mode, it is inconvenient. However, the relay device 100 of the present embodiment can alleviate such inconvenience.

Further, in the present embodiment, the designated data described above is transmitted in a state where the designated data is contained in the probe request 10. As a result, by performing process for transmitting the probe request from the wireless communications terminal 900a to the relay device 100 as usually performed when the wireless communications compliant with the IEEE 802.11 standard is started, the relay device 100 operating in the second mode can be switched so as to be in the first mode. Therefore, it is unnecessary to perform specific communications for only switching the operation mode of the relay device 100 from the second mode to the first mode. As a result, the operation mode of the relay device 100 can be switched without performing unnecessary communications between the relay device 100 and the wireless communications terminal 900a.

Moreover, according to the present embodiment, in a state where the relay device 100 is in the second mode, the data receiving section 314 and the data transmitting section 312 of the first communications module 310 do not operate (power supply is stopped), and the data receiving section 322 of the second communications module 320 which consumes less power than the data receiving section 314 operates (power is being supplied). Therefore, in a state where the relay device 100 is in the second mode, power consumption in the relay device 100 can be reduced. The determination section 417 determines whether the data receiving section 322 receives designated data (the BSSID, the security code, and the switching command as described above) in the wake-up process (FIG. 4). Therefore, in a state where the relay device 100 is in the second mode, the determination section 417 can determine whether the designated data is received even when the data receiving section 314 does not operate. As a result, the mode switching section 416 can switch the operation mode of the relay device 100 from the second mode to the first mode in the wake-up process, based on the determination made by the determination section 417.

Further, according to the present embodiment, the control section 400 of the relay device 100 switches the operation mode from the second mode to the first mode in the wake-up process (FIG. 4) when requirements that a received BSSID matches the BSSID 332d contained in the identification data storage section 332 are satisfied (see FIG. 4: Step S20). Therefore, the relay device 100 can appropriately switch the operation mode in the wake-up process according to a request from the wireless communications terminal which can use the BSSID which matches the BSSID 332d stored in the identification data storage section 332, that is, according to a request from the wireless communications terminal (for example, the wireless communications terminal 900a) of which the communications partner is the relay device 100.

Moreover, according to the present embodiment, the control section 400 of the relay device 100 switches the operation mode from the second mode to the first mode in the wake-up process (FIG. 4) when requirements that the received security code is authenticated according to the comparison with the security code 610 stored in the authentication data storage unit 600 are satisfied (see FIG. 4: Step S30). Therefore, the relay device 100 can appropriately switch the operation mode in the wake-up process according to a request from the wireless communications terminal which can use a security code which is authenticated according to the comparison with the security code 610 stored in the authentication data storage unit 600, that is, according to a request from the wireless communications terminal (for example, the wireless communications terminal 900a) which ensures security.

Moreover, according to the present embodiment, the control section 400 of the relay device 100 does not switch the operation mode of the relay device 100 in the wake-up process (FIG. 4), when it is determined that the designated data (the BSSID, the security code, and the switching command described above) is not received. Therefore, the relay device 100 can minimize unintended mode switching performed by the wireless communications terminal which cannot use the designated data, in the wake-up process. Specifically, it is possible to minimize, for example, illegitimate switching of the operation mode of the relay device 100 which is performed by the wireless communications terminal which cannot use the designated data (the BSSID, the security code, and the switching command).

It is to be noted that, according to the present embodiment, the designated data are three types of data, that is, the BSSID which matches the BSSID 332d stored in the identification data storage section 332, the security code which is authenticated according to the comparison with the security code 610 stored in the authentication data storage unit 600, and the switching command. However, the number of types of the designated data may not be three, that is, all of the BSSID, the security code, and the switching command may not be used as the designated data. The designated data may be any one or two of these three types of data.

### Second Embodiment

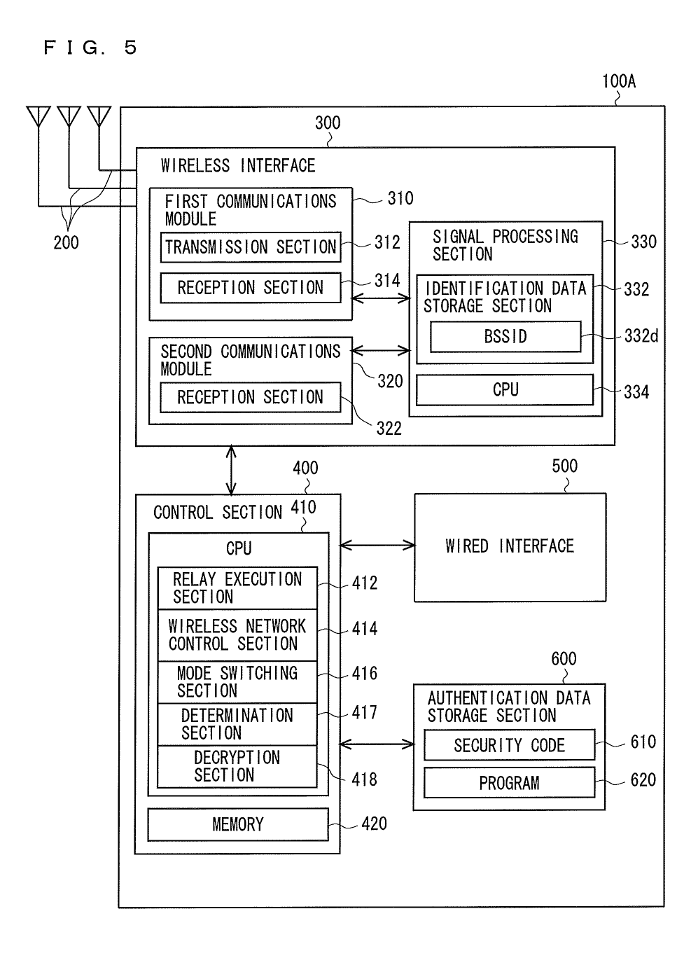

A structure of a second embodiment will be described. FIG. 5 is a block diagram illustrating a configuration of a relay device 100A in a network system according to the present embodiment. The relay device 100A in the network system of the present embodiment is different from the relay device 100 of the first embodiment in that, in the relay device 100A, the CPU 410 of the control section 400 includes a decryption section 418. The components of the relay device 100A other than the decryption section 418 are the same as those of the relay device 100 according to the first embodiment. Further, in the network system of the present embodiment, the control section 920 of the wireless communications terminal 900a (FIG. 1) includes an encryption section (illustration omitted) for encrypting data in a predetermined encryption method. The configuration of the network system of the present embodiment other than the difference described above is the same as that of the network system 1000 of the first embodiment. In the network system of the present embodiment, the same components as those of the network system 1000 of the first embodiment are denoted by the same reference numerals as used for the network system 1000, and the description thereof is not given. The relay device 100A performs wake-up process different from the wake-up process (FIG. 4) of the first embodiment. Further, the decryption section 418 performs decryption process in the wake-up process of the present embodiment.

In the relay device 100A, as in the relay device 100 of the first embodiment, when the operation mode is the second mode (power-saving mode), the first communications module 310 does not operate, so that the relay device 100A cannot perform two-way communications with the wireless communications terminal 900a. Therefore, as in the first embodiment, a mechanism for enabling the operation mode of the relay device 100A to be switched by using a probe request used at the start of wireless communications which are compliant with, for example, the IEEE 802.11 standard, is utilized for the relay device 100A and the wireless communications terminal 900a of the present embodiment. In the present embodiment, as in the first embodiment, when the wireless communications terminal 900a starts wireless communications with the relay device 100A, the designated data transmitting section 912 of the wireless communications terminal 900a transmits a probe request to the relay device 100A in order to communicate with the relay device 100A. In this case, the encryption section of the wireless communications terminal 900a encrypts, in a predetermined encryption method, contents of the vendor specific field in the probe request 10 (see FIG. 3) as described in the first embodiment. The designated data transmitting section 912 transmits, to the relay device 100A, the probe request containing the encrypted contents. It is to be noted that, for example, ARCFOUR (Alleged Rivest Cipher Four) can be used as the predetermined encryption method. When a key (encryption key) is used for the encryption, the encryption section of the wireless communications terminal 900a may use a predetermined encryption key. Alternatively, the encryption section may use an encryption key determined by a user.

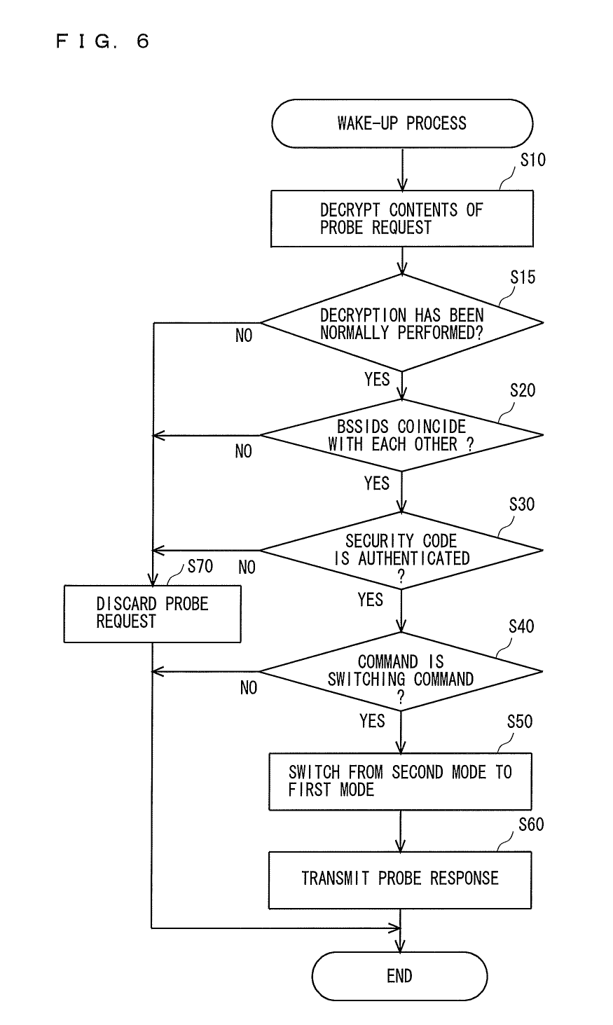

Next, the wake-up process performed by the relay device 100A will be described. FIG. 6 is a flow chart showing the wake-up process performed by the relay device 100A according to the second embodiment. The wake-up process is executed by the relay device 100A when the data receiving section 322 of the relay device 100A receives the probe request in a state where the operation mode of the relay device 100A is the second mode. In the wake-up process, the same process steps as those of the wake-up process (FIG. 4) of the first embodiment are denoted by the same step numbers as described for the wake-up process of the first embodiment.

When the wake-up process of the present embodiment is started, the decryption section 418 of the relay device 100A performs decryption process for decrypting the probe request received by the data receiving section 322 (Step S10). Specifically, the decryption section 418 transforms data corresponding to the contents of the vendor specific field in the probe request, into original data which is data having not been encrypted, by performing the decryption process. When a key (decryption key) is used for the decryption, the decryption section 418 may use a predetermined decryption key. Alternatively, the decryption section 418 may use a decryption key determined by a user. Hereinafter, data obtained by the transformation in the decryption process may be also referred to as contents original data.

The determination section 417 determines whether the decryption is normally performed by the decryption section 418 in the process step of Step S10 (Step S15). For example, the determination section 417 determines that the decryption is normally performed when the decryption by the decryption section 418 is ended without error. When an error occurs in the decryption, the determination section 417 determines that the decryption is not normally performed. In general, when the encryption key is an effective key based on the decryption key used by the decryption section 418, the decryption by the decryption section 418 is ended without error.

When the determination section 417 determines that the decryption by the decryption section 418 is normally performed (Step S15:YES), the BSSID 332d is read from the identification data storage section 332 of the signal processing section 330. The determination section 417 determines whether the read BSSID 332d matches the BSSID contained in the contents original data obtained through the transformation by the decryption section 418 in the decryption process (Step S20).

When the determination section 417 determine that the read BSSID 332d matches the BSSID contained in the contents original data obtained through the transformation by the decryption section 418 in the decryption process (Step S20:YES), the determination section 417 performs authentication of the security code contained in the contents original data (Step S30). Specifically, the determination section 417 reads the security code 610 from the authentication data storage section 600. The determination section 417 compares the read security code 610 with the security code contained in the contents original data obtained through the transformation by the decryption section 418 in the decryption process, to perform authentication of the security code contained in the contents original data (Step S30).

When the determination section 417 authenticates the security code contained in the contents original data (Step S30:YES), the determination section 417 determines that the probe request received by the data receiving section 322 is a probe request from an authenticated wireless communications terminal. The determination section 417 determines whether a command contained in the contents original data is the switching command (Step S40).

When the determination section 417 determines that the command contained in the contents original data is the switching command (Step S40:YES), the mode switching section 416 switches the operation mode of the relay device 100A from the second mode to the first mode (Step S50).

On the other hand, when the determination section 417 determines that the decryption by the decryption section 418 is not normally performed (Step S15:NO), the probe request is discarded (Step S70). Further, also when the determination section 417 determines that the read BSSID 332d does not match the BSSID contained in the contents original data obtained through the transformation by the decryption section 418 in the decryption process (Step S20:NO), the probe request is discarded (Step S70). Furthermore, also when the determination section 417 determines that a BSSID is not contained in the contents original data obtained through the transformation by the decryption section 418 in the decryption process, the probe request is discarded. After the probe request is discarded, the relay device 100A ends the wake-up process.

Further, when the determination section 417 does not authenticate the security code contained in the contents original data, according to comparison between the read security code 610 with the security code contained in the contents original data obtained through the transformation by the decryption section 418 in the decryption process (Step S30:NO), the probe request is discarded (Step S70). Moreover, also when the determination section 417 determines that the security code is not contained in the contents original data obtained through the transformation by the decryption section 418 in the decryption process, the probe request is discarded. After the probe request is discarded, the relay device 100A ends the wake-up process.

When the determination section 417 determines that the command contained in the contents original data is a command other than the switching command (Step S40:NO), or when the probe request contains no command, the wake-up process is ended. When the probe request contains a command other than the switching command, the relay device 100A thereafter performs a specific process based on the command.

The network system according to the present embodiment realizes at least the following functions and effects, in addition to the same functions and effects as realized in the first embodiment. The mode switching section 416 of the relay device 100A switches the operation mode of the relay device 100A from the second mode to the first mode in the wake-up process (FIG. 6) based on the contents original data obtained through the transformation by the decryption section 418 in the decryption process. In other words, the mode switching section 416 switches the operation mode of the relay device 100A from the second mode to the first mode when the requirements that the data (contents) which can be decrypted by the decryption section 418 is received by the data receiving section 322 are satisfied. Therefore, the relay device 100A can appropriately switch the operation mode according to a request from the wireless communications terminals capable of using an encryption method which allows decryption by the decryption section 418. Namely, the relay device 100A can restrict switching of the operation mode by wireless communications terminals which cannot use an encryption method that allows decryption by the decryption section 418. As a result, it is possible to restrain wireless communications terminals which cannot use an encryption method that allows decryption by the decryption section 418, from switching the operation mode of the relay device 100A.

### Third Embodiment

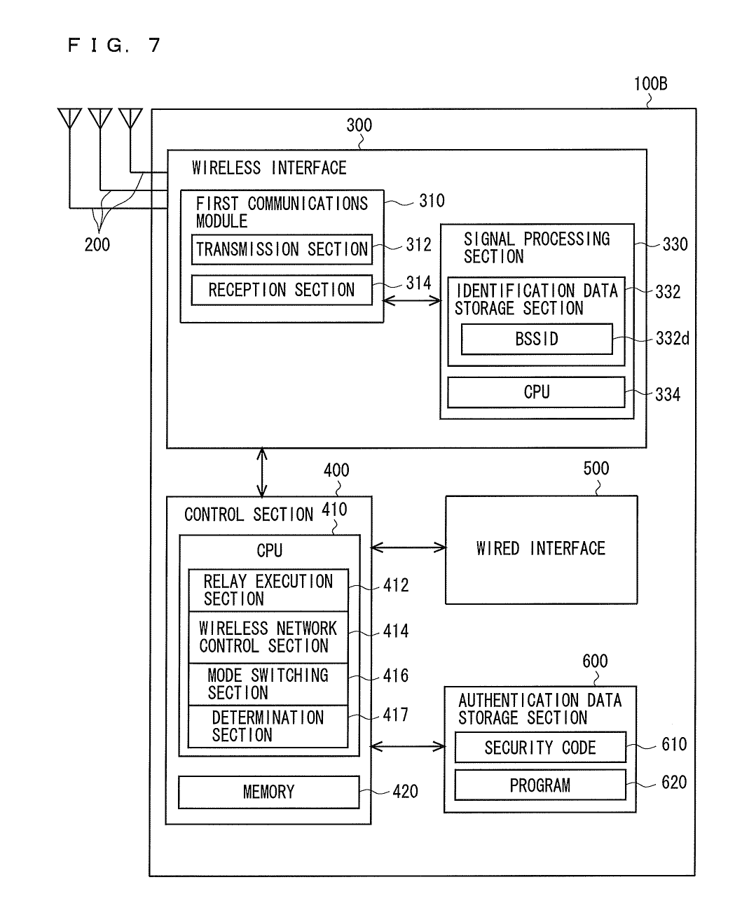

A configuration of a third embodiment will be described. FIG. 7 is a block diagram illustrating a configuration of a relay device 100B in a network system according to the present embodiment. The relay device 100B of the network system of the present embodiment is different from the relay device 100 of the first embodiment in that the mode switching section 416 of the third embodiment has a function different from that of the mode switching section 416 of the first embodiment, and the wireless interface 300 of the relay device 100B does not include the second communications module 320. The components of the relay device 100B of the present embodiment other than the difference described above are the same as the components of the relay device 100 of the first embodiment. The configuration of the network system of the present embodiment other than the relay device 100B is the same as that of the network system 1000 of the first embodiment. The difference from the first embodiment will be described below, and description of the same configuration is not given.

When the mode switching section 416 of the present embodiment switches the operation mode of the relay device 100B so as to operate the relay device 100B in the first mode (normal operation mode), power is supplied from the designated power supply to the data transmitting section 312 and the data receiving section 314 to operate the data transmitting section 312 and the data receiving section 314. On the other hand, when the mode switching section 416 switches the operation mode of the relay device 100B to operate the relay device 100B in the second mode (power-saving mode), power is supplied to the data receiving section 314 to operate the data receiving section 314, while no power is supplied to the data transmitting section 312, and the data transmitting section 312 is not operated.

The relay device 100B of the present embodiment performs the same wake-up process as the wake-up process (FIG. 4) of the first embodiment when the data receiving section 314 receives the probe request in a state where the operation mode of the relay device 100B is the second mode. However, in the present embodiment, switching from the second mode to the first mode specifically means that a state in which no power is supplied to the data transmitting section 312, and the data transmitting section 312 is not operated, is shifted to a state where power is supplied to the data transmitting section 312 to operate the data transmitting section 312.

The network system of the present embodiment can realize at least the following functions and effects, in addition to improvement of usability of the relay device 100 which executes a mode for minimizing power consumption as in the first embodiment. In the network system of the present embodiment, the relay device 100B does not include the second communications module 320. Therefore, the number of components used for the relay device 100B can be reduced. Further, the relay device 100B can use the wireless interface 300 which is compact, resulting in reduction in size.

The present invention is not limited to the embodiments as described above, and numerous other modifications and variations can be devised without departing from the gist of the invention. Modifications will be described below.

(Modification 1)

In the network systems of the embodiments described above, the relay device may be a device which can relay among a plurality of networks, and the following configuration may be applied, for example. Namely, the relay device may be a wireless LAN router or a switching hub. For example, when the relay device is a wireless LAN router, the relay execution section 412 relays communications by realizing a so-called routing function (layer 3 level relay function). Information (for example, route information (also referred to as a routing table) necessary for the routing function is stored in the authentication data storage section 600. It is to be noted that the relay execution section 412 may realize, instead of the routing function, another function (for example, a so-called bridging function (layer 2 level relay function)) for relaying communications. The layer 3 corresponds to the third layer (network layer) of the OSI reference model.

(Modification 2)

The function (hereinafter, also referred to as wake-up function) for performing the wake-up process of the relay device in each of the embodiments described above can be applied to various devices as well as the relay device. For example, communications devices such as mobile telephones, PHSs, PDAs, and game apparatuses having communications function may have the wake-up function. In a case where a game apparatus having communications function has the wake-up function, when, for example, the game apparatus receives designated data transmitted from another game apparatus in a state where the operation mode of the game apparatus is the second mode which is the power-saving mode, the second mode is switched to the first mode in which the power-saving state is released. Examples of the designated data include identification information (ID) for identifying the game apparatus, and the security code.

(Modification 3)

In each of the relay devices 100 and 100A of the network systems according to the first embodiment and the second embodiment, respectively, no power is supplied to the second communications module 320 when the operation mode is the first mode. However, the present invention is not limited thereto. In each of the relay devices 100 and 100A, power may be supplied to the second communications module 320 when the operation mode is the first mode. In this configuration, each of the relay devices 100 and 100A need not perform process for stopping supply of power to the second communications module 320 in order to switch the operation mode from the second mode to the first mode. Therefore, for example, a configuration for stopping supply of power can be eliminated from each of the relay devices 100 and 100A, and simple configuration can be designed.

(Modification 4)

In each of the relay devices 100 and 100A of the network systems according to the first embodiment and the second embodiment, respectively, no power is supplied to the first communications module 310 when the operation mode is the second mode. However, the present invention is not limited thereto. In each of the relay devices 100 and 100A, power may be supplied to the first communications module 310 when the operation mode is the second mode. In this case, power supplied by each of the relay devices 100 and 100A is lower than power supplied in the first mode. In this configuration, each of the relay devices 100 and 100A can enable a portion of the function of each of the data transmitting section 312 and the data receiving section 314 also when the operation mode is the second mode.

(Modification 5)

In the network systems according to the first embodiment and the third embodiment, the mode switching section 416 and the determination section 417 of each of the relay devices 100 and 100B for executing the wake-up process are included in the control section 400. However, the present invention is not limited thereto. The mode switching section 416 and the determination section 417 for executing the wake-up process may be included in, for example, the signal processing section 330, and each of the relay devices 100 and 100B may stop at least a portion of the functions of the control section 400 when the operation mode is the second mode. In this configuration, each of the relay devices 100 and 100B can enhance restriction of consumed power when the operation mode is the second mode. In this case, for example, in the wake-up process, when the operation mode of each of the relay devices 100 and 100B is switched from the second mode to the first mode based on the switching command, the mode switching section 416 and the determination section 417 included in the signal processing section 330 instruct the control section 400 to enable functions which have been stopped in the control section 400.

(Modification 6)

In the network system according to the second embodiment, the mode switching section 416, the determination section 417, and the decryption section 418 of the relay device 100A for executing the wake-up process are included in the control section 400. However, the present invention is not limited thereto. The mode switching section 416, the determination section 417, and the decryption section 418 for executing the wake-up process may be included in, for example, the signal processing section 330, and the relay device 100A may stop at least a portion of the functions of the control section 400 when the operation mode is the second mode. In this configuration, the relay device 100A can enhance restriction of consumed power when the operation mode is the second mode. In this case, for example, in the wake-up process, when the operation mode of the relay device 100A is switched from the second mode to the first mode based on the switching command, the mode switching section 416, the determination section 417, and the decryption section 418 included in the signal processing section 330 instructs the control section 400 to enable functions which have been stopped in the control section 400.

(Modification 7)

In the network systems according to the embodiments described above, each of the relay devices 100, 100A, and 100B switches the operation mode from the second mode to the first mode in the wake-up process when an authenticated BSSID, an authenticated security code, and the switching command are received. However, the present invention is not limited thereto. For example, the following modes can be applied to the relay devices.

(Mode 1)

In the wake-up process, when an authenticated security code and the switching command are received, the relay device may switch the operation mode from the second mode to the first mode without determining whether an authenticated BSSID is received. Specifically, in FIG. 4 and FIG. 6, Step S20 may be skipped.

(Mode 2)

In the wake-up process, when an authenticated BSSID and the switching command are received, the relay device may switch the operation mode from the second mode to the first mode without determining whether an authenticated security code is received. Specifically, in FIG. 4 and FIG. 6, Step S30 may be skipped.

(Mode 3)

In the wake-up process, when the switching command is received, the relay device may switch the operation mode from the second mode to the first mode without determining whether an authenticated BSSID and an authenticated security code are received. Specifically, in FIG. 4 and FIG. 6, Step S20 and Step S30 may be skipped.

(Mode 4)

In general, the relay device stores the ESSID (extended service set identifier) in a memory (for example, the authentication data storage section 600 of each embodiment described above). Further, the probe request contains an ESSID field in which the ESSID is written. Therefore, the relay device may determine whether the ESSID stored in the memory matches the ESSID written in the ESSID field of the probe request, in Step S20 of FIG. 4 and FIG. 6 during the wake-up process, instead of determining whether the BSSID stored in the identification data storage section matches the BSSID written in the BSSID field of the probe request. When a plurality of the relay devices as described above are provided and the same ESSID is set in each relay device, by transmitting the probe request, the wireless communications terminal selects, from among the plurality of relay devices, a relay device provided at a position which allows wireless communications with the wireless communications terminal, to enable the operation mode of the selected relay device to be switched from the second mode to the first mode.

(Mode 5)

In the wake-up process, when the probe request is received, the relay device may switch the operation mode from the second mode to the first mode without determining whether an authenticated BSSID, an authenticated security code, and the switching command are received. Specifically, in FIG. 4 and FIG. 6, Steps S20, S30, and S40 may be skipped. Further, in FIG. 6, Step S10 may be skipped. In this configuration, the relay device 100 can switch the operation mode in the wake-up process by performing simple process. In this case, it can be said that the probe request itself is the designated data for switching the operation mode.

(Mode 6)

When, instead of the probe request, a specific command indicating instruction for execution of the wake-up process is received, the relay device may switch the operation mode from the second mode to the first mode in the wake-up process. In this case, in FIG. 4 and FIG. 6, Steps S20, S30, and S40 may be skipped. Further, in FIG. 6, Step S10 may be skipped. In this configuration, the relay device 100 can switch the operation mode in the wake-up process by performing simple process. In this case, it can be said that the specific command is the designated data for switching the operation mode.

(Modification 8)

In the network system according to the second embodiment, the wireless communications terminal 900a encrypts the contents of the vendor specific field in the probe request 10, to transmit data. However, the present invention is not limited thereto. For example, the wireless communications terminal 900a may encrypt at least one of the BSSID, the security code, and the switching command which are contained, as the designated data, in the contents of the vendor specific field in the probe request 10, to transmit data. In this case, the relay device 100A transforms, into original data, the encrypted data among the data contained in the received probe request as described above, in the decryption process in the wake-up process (FIG. 6). In any of Steps S20, S30, and S40, the relay device 100A may perform the determination for the encrypted data, based on the original data obtained by the transformation.

(Modification 9)

In each embodiment, each component may be realized by hardware or software. For example, the function of the mode switching section 416 shown in FIG. 2 may be realized by a dedicated hardware circuit. Furthermore, the functions of the designated data transmitting section 912 and the designated data receiving section 914 shown in FIG. 1 may be realized by a computer for executing programs.

Further, when a portion or the entirety of the functions of the present invention is realized by software, the software (computer program) may be stored in a non-transitory computer-readable storage medium, and provided. In the present invention, examples of the “non-transitory computer-readable storage medium” include an internal storage device of a computer such as various types of RAMs and ROMs, and an external storage device, such as a hard disk, secured to the computer, as well as a portable storage medium such as a flexible disk and a CD-ROM.

While the invention has been described in detail, the foregoing description is in all aspects illustrative and not restrictive. For example, additional components may be omitted as necessary in view of the gist of the present invention. It should be understood that numerous other modifications and variations, in addition to the medications and modes described above, can be devised without departing from the scope of the invention.

What is claimed is:

1. A communications device for performing wireless communications, the communications device comprising:
a data receiving section for receiving data by wireless communications;
a data transmitting section for transmitting data by wireless communications;
a mode switching section for switching an operation mode of the communications device between a first mode in which power is supplied to the data transmitting section, and a second mode in which power consumption in at least the data transmitting section is minimized over that in the first mode; and
a determination section for determining whether the data receiving section has received designated data; wherein
the mode switching section switches the operation mode of the communications device from the second mode to the first mode if, in a state in which the communications device is in the second mode, the determination section has determined that the data receiving section has received the designated data.

2. The communications device according to claim 1, wherein:
the data receiving section includes a first data receiving unit that operates in the first mode and does not operate in the second mode, and a second data receiving unit that consumes less power than the first data receiving unit and operates in the second mode;
the determination section determines whether the second data receiving unit has received the designated data; and
the mode switching section switches the operation mode of the communications device from the second mode to the first mode if, in a state in which the communications device is in the second mode, the determination section has determined that the second data receiving unit has received the designated data.

3. The communications device according to claim 1, wherein:
the communications device is a relay device that relays communications data between a wireless communications terminal and another communications device;
the data receiving section receives communications data from the wireless communications terminal and said other communications device by wireless communications, and
the data transmitting section transmits communications data to the wireless communications terminal and said other communications device by wireless communications.

4. The communications device according to claim 1, further comprising an identification data memory section storing identification data for identifying the communications device; wherein
the designated data includes identification data matching the identification data stored in the identification data memory section.

5. The communications device according to claim 1, further comprising an authentication data memory section storing authentication data, wherein
the designated data includes authentication data that is deemed legitimate by being compared with the authentication data stored in the authentication data memory section.

6. The communications device according to claim 1, wherein the mode switching section does not carry out switching of the communications device operation mode if, in a state in which the communications device is in the second mode, the determination section determines that the data receiving section has not received the designated data.

7. The communications device according to claim 1, wherein:
the data receiving section receives encrypted data;
the communications device further comprises a decryption section for transforming, by a decryption process, the encrypted data into the original data that the data was prior to being encrypted; and
the determination section determines that the data receiving section has received the designated data if the original data is the designated data.

8. The communications device according to claim 1, wherein the designated data is contained in a probe request.

9. A wireless communications system comprising:
a first communications device; and
a second communications device for performing wireless communications with the first communications device; wherein:
the first communications device includes a designated data transmitting section for transmitting designated data to the second communications device by wireless communications; and
the second communications device includes
a data receiving section for receiving data from the first communications device by wireless communications,
a data transmitting section for transmitting data to the first communications device by wireless communications,
a mode switching section for switching an operation mode of the second communications device between a first mode in which power is supplied to the data transmitting section, and a second mode in which power consumption in at least the data transmitting section is minimized over that in the first mode, and
a determination section for determining whether the data receiving section has received the designated data,
the mode switching section of the second communications device switching the operation mode of the second communications device from the second mode to the first mode if, in a state in which the second communications device is in the second mode, the determination section has determined that the data receiving section has received the designated data.

10. A communications device for performing wireless communications, the communications device comprising a designated data transmitting section for transmitting designated data for switching, in respect of another communications device having, as operation modes, a first mode in which power is supplied to its data transmitting section for transmitting data by wireless communications and a second mode in which power consumption in at least the data transmitting section is minimized over that in the first mode, the operation mode of the other communications device from the second mode to the first mode.

11. A method for performing wireless communications between a first communications device having a data transmitting section and a data receiving section, and a second communications device, the method comprising:
a step, performed by the first communications device, of waiting for reception of designated data in a state in which power consumption in at least the data transmitting section is restricted;
a step, performed by the second communications device, of transmitting the designated data to the first communications device by wireless communications; and
a step, performed by the first communications device, of releasing the power-consumption restriction if the data receiving section has received the designated data.

12. A non-transitory computer-readable storage medium having stored therein a program executable by a communications device having a data transmitting section and a data receiving section, the program causing the communications device to perform a wireless communications method comprising:
a step of waiting for reception of designated data in a state in which power consumption in at least the data transmitting section is restricted; and
a step of releasing the power-consumption restriction if the data receiving section has received the designated data.

13. A non-transitory computer-readable storage medium having stored therein a program executable by a communications device for performing wireless communications, the program causing the communications device to perform a wireless communications method comprising a step of transmitting designated data for switching, in respect of another communications device having, as operation modes, a first mode in which power is supplied to its data transmitting section for transmitting data by wireless communications and a second mode in which power consumption in at least the data transmitting section is minimized over that in the first mode, the operation mode of the other communications device from the second mode to the first mode.

14. A wireless network access point comprising:
a transmit/receive communications module having data transmitting and receiving units amplifying communications signals at first power level, said transmit/receive communications module therein handing data communications at a first speed;
a non-transmitting communications module having a receiving unit amplifying communications signals at second power level lower than said first power level, said non-transmitting communications module therein handing data communications at a second speed slower than said first speed, and said non-transmitting communications module being configured to receive wakeup data specific to the access point;
a signal processor operatively associated with, for processing communications signals received via, said transmit/receive communications module and said non-transmitting communications module, said signal processor having an identification-data memory unit storing access-point-specific identification data;
an authentication memory unit storing wakeup-data authentication data;
a control module for operatively controlling said transmit/receive communications module and said non-transmitting communications module;
a determination unit in said control module, operatively associated with said signal processor and said authentication memory unit, said determination unit therein configured to authenticate access-point-specific wakeup data received from said non-transmitting communications module via said signal processor, and to send authenticated wakeup data to said control module; and
a power supply;
a mode-switching unit in said control module and operatively associated with said power supply, said mode-switching unit configured to switch, in response to authenticated wakeup data received from said determination unit, access-point operation into a first mode, in which via said mode-switching unit power is supplied to said transmit/receive communications module and in which power is blocked from being supplied to said non-transmitting communications module, and to switch, in response to date/time settings, access-point operation into a second mode, in which via said mode-switching unit power is blocked from being supplied to said transmit/receive communications module and in which power is supplied to said non-transmitting communications module.
